(19) United States
(12) Patent Application Publication
(10) Pub. No.: US 2009/0237835 A1
(43) Pub. Date: Sep. 24, 2009

(54) Switching field controlled (SFC) media using anti-ferromagnetic thin layer in magnetic recording

(75) Inventors: Sooyoul Hong, Santa Clara, CA (US); Kiseok Moon, Pleasanton, CA (US); Carl (Xiao) Che, Saratoga, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 12/077,814

(22) Filed: Mar. 20, 2008

(51) Int. Cl. G11B 5/012; B05D 5/12

(52) U.S. Cl. 360/97.01; 428/800; 427/128

(57) ABSTRACT

A patterned disk for a hard disk drive. The patterned disk includes an anti-ferromagnetic layer of FeₓNi₁₋ₓO over a substrate. The disk also includes a magnetic layer that is adjacent to the anti-ferromagnetic layer of FeₓNi₁₋ₓO, and is formed into a plurality of dots separated by a non-magnetic material. The anti-ferromagnetic layer of FeₓNi₁₋ₓO with the magnetic layer create an exchange-spring system that has a relatively low switching field. The anti-ferromagnetic layer of FeₓNi₁₋ₓO has a Neel temperature that maintains thermal stability. The low switching field improves reliability when the disk is a bit pattern media used in perpendicular recording.

### BACKGROUND OF THE INVENTION

1. Field of the Invention

The subject matter disclosed generally relates to disk media of hard disk drives.

2. Background Information

Hard disk drives contain a plurality of heads that are magnetically coupled to rotating disks. The heads write and read information by magnetizing and sensing the magnetic fields of the disk surfaces.

There are generally two different types of magnetic heads, horizontal recording heads and perpendicular recording heads (“PMR heads”). Horizontal recording heads magnetize the disk in a direction that is essentially parallel with the outer surface of the disk. PMR heads magnetize the disk in a direction essentially perpendicular to the outer surface of the disk. PMR heads are preferred because perpendicular recording allows for higher bit densities and corresponding increases in the data capacity of the drive.

The areal density of perpendicular recording is limited by magnetic cross-talk between adjacent areas of the disks. One approach to limiting cross-talk is to create a disk composed of a plurality of magnetic dots that are separated by non-magnetic material. The non-magnetic material inhibits magnetic cross-talk between the magnetic dots. Such disks are commonly referred to as bit patterned media.

When writing on a bit patterned media the recording head must switch polarity while the write element of the head is adjacent to the magnetic dot. If the polarity is not switch during a critical window the dot is not re-magnetized and data is not properly written to disk. Consequently, bit patterned media have stringent writing requirements.

### BRIEF SUMMARY OF THE INVENTION

A patterned disk for a hard disk drive. The patterned disk includes an anti-ferromagnetic layer of FeₓNi₁₋ₓO over a substrate. The disk also includes a magnetic layer that is adjacent to the anti-ferromagnetic layer of FeₓNi₁₋ₓO, and is formed into a plurality of dots separated by a non-magnetic material.

### BRIEF DESCRIPTION OF THE DRAWINGS

FIG. 1 is a top view of a hard disk drive;

FIG. 2 is an illustration of a cross-section of a disk of the hard disk drive;

FIGS. 3a-c are illustrations showing the spin configurations within a magnetic material and an adjacent anti-ferromagnetic layer of FeₓNi₁₋ₓO exposed to different levels of an external magnetic field H;

FIG. 4 is an enlarged top view of the disk showing a plurality of magnetic dots.

### DETAILED DESCRIPTION

Disclosed is a patterned disk for a hard disk drive. The patterned disk includes an anti-ferromagnetic layer of FeₓNi₁₋ₓO over a substrate. The disk also includes a magnetic layer that is adjacent to the anti-ferromagnetic layer of FeₓNi₁₋ₓO, and is formed into a plurality of dots separated by a non-magnetic material. The anti-ferro-magnetic layer of FeₓNi₁₋ₓO with the magnetic layer create an exchange-spring system that has a relatively low switching field. The anti-ferromagnetic layer of FeₓNi₁₋ₓO has a Neel temperature that maintains thermal stability. The low switching field improves reliability when the disk is a bit pattern media used in perpendicular recording.

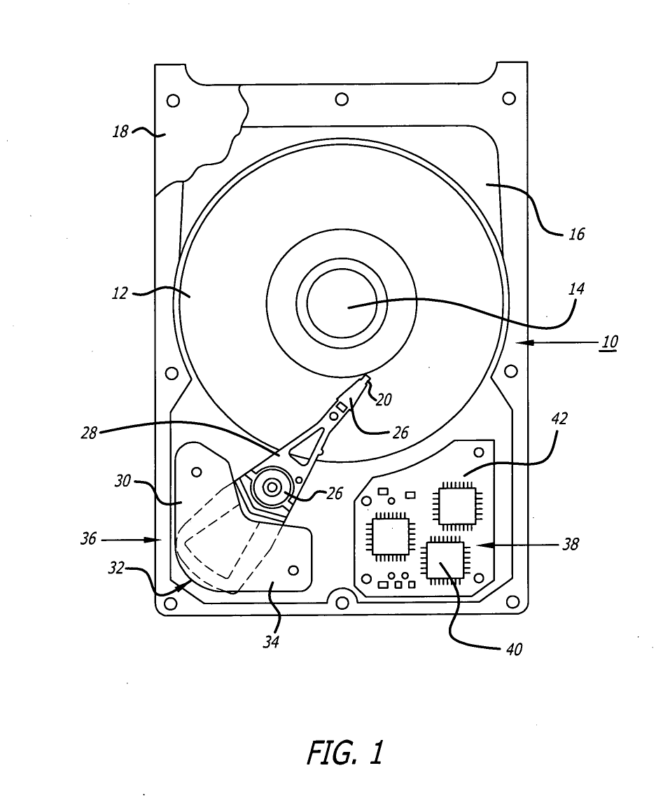

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The air bearing separates the head 20 from the disk surface to minimize contact and wear.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

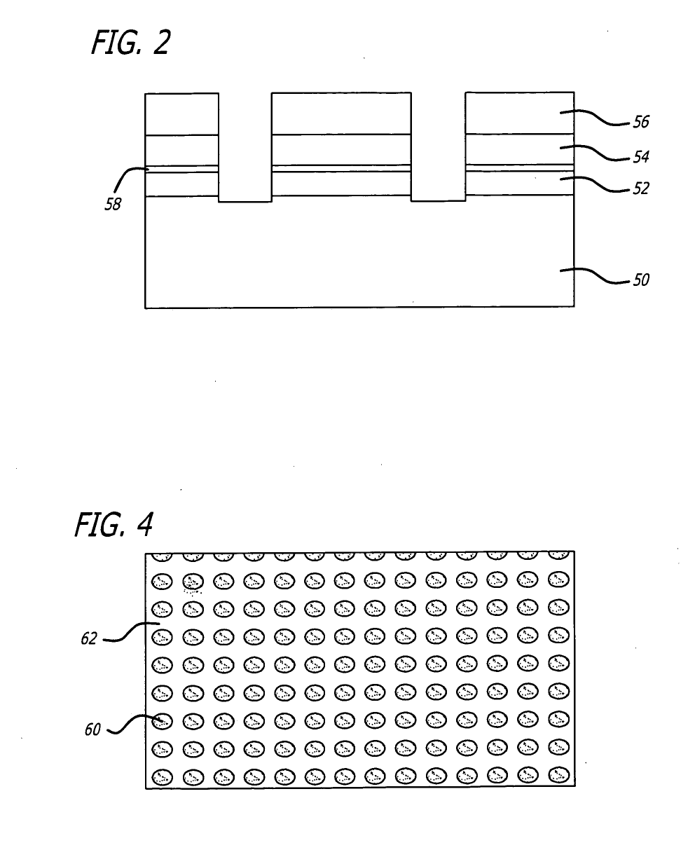

FIG. 2 shows an embodiment of the disk 12. The disk 12 includes a substrate 50 that supports an underlayer 52. The underlayer 52 may include an adhesion layer, an AFC layer, a blocking layer and an intermediate layer as is known in the art. The disk 12 includes a magnetic layer 54 and a protective layer 56. The protective layer 56 may include carbon-like material as is known in the art.

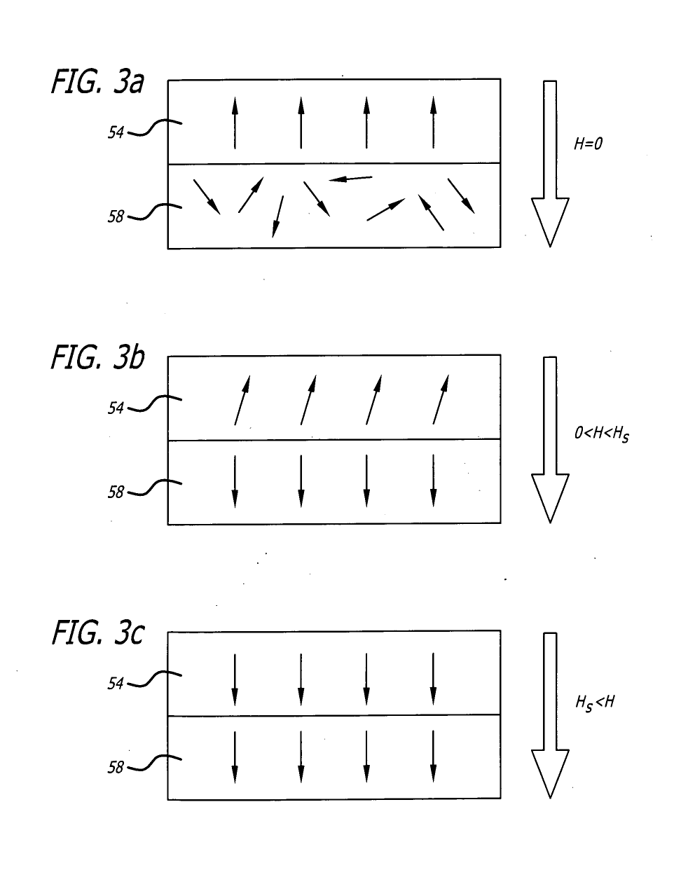

The disk 12 further includes an anti-ferromagnetic layer of FeₓNi₁₋ₓO 58. As shown in FIGS. 3a-c, the combination of the magnetic layer and anti-ferromagnetic layer 58 creates a spring-exchange system that lower the coercivity and corresponding switching field of the media.

As shown in FIG. 3a, when the external field is zero, the magnetic material is magnetized in a certain direction and the FeₓNi₁₋ₓO layer is not magnetized. FIG. 3b shows the application of an external field in a polarity opposite from the polarity at which the magnetic layer is magnetized and at an amplitude below a threshold H_{S}. The FeₓNi₁₋ₓO layer becomes magnetized in the direction of the external field H. The direction of magnetization in the magnetic field remains in an opposite direction. As shown in FIG. 3c, both layers 54 and 58 become magnetized in the direction of the magnetic field when the external magnetic field H exceeds the threshold H_{S}.

When used with a perpendicular recording head the low switching field increases the switching window in which the head can re-magnetize the disk. This relaxes the timing requirements of writing data onto the disk. The FeₓNi₁₋ₓO material has a Neel temperature between 200° to 520° K and thus will maintain the para-magnetic characteristics shown in FIGS. 3a-c, even at temperatures below ambient.

As shown in FIG. 4, the magnetic layer 54 is arranged into a plurality of dots 60 that are separated by non-magnetic material 62 such as air. The non-magnetic material inhibits magnetic cross-talk between the magnetic dots 62.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A patterned magnetic disk for a hard disk drive, comprising:
a substrate;
an anti-ferromagnetic layer of FeₓNi₁₋ₓO over said substrate;
a magnetic layer adjacent to said anti-ferromagnetic layer of FeₓNi₁₋ₓO, said magnetic layer being formed into a plurality of dots separated by a non-magnetic material, said anti-ferromagnetic layer being magnetized at a lower threshold than said magnetic layer to create an exchange-spring system.

2. The disk of claim 1, further comprising an underlayer between said substrate and said magnetic layer.

3. The disk of claim 1, further comprising a protective layer over said magnetic layer.

4. A hard disk drive, comprising:
a base plate;
a spindle motor coupled to said base plate;
a disk coupled to said spindle motor, said disk including;
a substrate;
an anti-ferromagnetic layer of FeₓNi₁₋ₓO over said substrate;
a magnetic layer adjacent to said anti-ferromagnetic layer of FeₓNi₁₋ₓO, said magnetic layer being formed into a plurality of dots separated by a non-magnetic material, said anti-ferromagnetic layer being magnetized at a lower threshold than said magnetic layer to create an exchange-spring system;
a voice coil motor coupled to said actuator arm; and,
a head coupled to said actuator arm and said disk.

5. The disk drive of claim 4, further comprising an underlayer between said substrate and said magnetic layer.

6. The disk drive of claim 4, further comprising a protective layer over said magnetic layer.

7. The disk drive of claim 4, wherein said head is a perpendicular recording head.

8. A method for fabricating a disk of a hard disk drive, comprising:
forming a anti-ferromagnetic layer of FeₓNi₁₋ₓO over a substrate;
forming a layer of magnetic material adjacent to the anti-ferromagnetic layer of FeₓNi₁₋ₓO, the layer of magnetic material being formed in a pattern that creates a plurality of dots separated by non-magnetic material, said anti-ferromagnetic layer being magnetized at a lower threshold than said magnetic layer to create an exchange-spring system.

9. The method of claim 8, further comprising forming an underlayer between the substrate and the anti-ferromagnetic layer of FeₓNi₁₋ₓO.

10. The method of claim 8, further comprising applying a protective layer over the magnetic layer.
